(19) United States
(12) Patent Application Publication
(10) Pub. No.: US 2016/0347005 A1
(43) Pub. Date: Dec. 1, 2016

(54) METHODS AND SYSTEMS FOR MONITORING MELT ZONES IN POLYMER THREE DIMENSIONAL PRINTING

(71) Applicant: EMPIRE TECHNOLOGY DEVELOPMENT LLC, Wilmington, DE (US)

(72) Inventor: Seth Adrian Miller, Englewood, CO (US)

(73) Assignee: EMPIRE TECHNOLOGY DEVELOPMENT LLC, Wilmington, DE (US)

(21) Appl. No.: 15/106,851

(22) PCT Filed: Mar. 24, 2014
(86) PCT No.: PCT/US14/31567

§ 371 Date: Jun. 21, 2016

(51) Int. Cl. B29C 67/00; B33Y 70/00; B33Y 40/00; B33Y 10/00; B33Y 30/00; G01J 5/10; B33Y 50/02

(52) U.S. Cl. CPC B29C 67/0088; G01J 5/10; B33Y 70/00; B33Y 50/02; B33Y 10/00; B33Y 30/00; B33Y 40/00; B29K 2105/0032

(57) ABSTRACT

Technologies are generally described for controlling fabrication of a 3D printed article by monitoring a temperature of an active growth region during a 3D printing of polymer material. A polymer material may be doped with one or more fluorescent molecules, which may be excited during a 3D printing of the polymer material. An intensity of light emitted from the fluorescent molecules may be determined to create a fluorescence intensity map, which may be converted into a temperature map in order to monitor a temperature of the active growth region, and generate one or more instructions based on the monitored temperature. One or more characteristics of the active growth region may then be modulated based on the instructions provided. Modulating characteristics of the active growth region based on the monitored temperature may allow better process control, which may be used to enhance a speed and resolution of 3D printing systems.

### BACKGROUND

Unless otherwise indicated herein, the materials described in this section are not prior art to the claims in this application and are not admitted to be prior art by inclusion in this section.

Precise temperature control may be favored in three-dimensional (3D) printing of articles composed of polymers due to polymer behavior in response to temperature. Polymers may behave non-linearly as a function of temperature. For example, polymers have properties, such as tensile strength, compressive strength, melt viscosity, and chemical stability, that are exponentially sensitive to temperature. Thus, a burden may be placed on 3D printing systems that print articles composed of polymers, such as thermoplastic resins, to achieve temperature control.

In a 3D printing system, thermal energy is generally provided into an active growth region to create a melt pool, and this thermal energy may radiate out to surrounding regions of the active growth region. A capability of the system to reproduce fine features in the printed article may depend on a size of the melt pool and thermal gradients around the active growth region. A way in which the thermal energy is distributed in and around the active growth region may be difficult to predict and model, as it may depend on a geometry of the article being printed, an environment of the printing equipment, a material used, and details of the printing process itself, for example, power applied and a density of surrounding materials.

As a result, designers of 3D articles produced from 3D printing systems adhere to design rules, such as limiting a wall thickness of articles and limiting high aspect ratio structures. These constraints may also indirectly limit the overall speed of the printing process, especially for larger articles. Current attempts in 3D printing systems to resolve such limitations could use improvements and/or alternative or additional solutions to allow in situ process control systems in order to monitor and control temperature during a 3D printing process.

### SUMMARY

The present disclosure generally describes methods, apparatus, systems, devices, and/or computer program products to control fabrication of a three-dimensional (3D) printed article by monitoring a temperature of an active growth region during 3D printing of polymer material.

According to some examples, methods for monitoring a temperature of an active growth region during 3D printing of polymer material are provided. An example method may include doping a polymer material with one or more fluorescent molecules and exciting the fluorescent molecules during a 3D printing of the polymer material. The example method may also include determining an intensity of light emitted from the fluorescent molecules to create a fluorescence intensity map and converting the fluorescence intensity map into a temperature map.

According to other examples, systems to monitor a temperature of an active growth region during 3D printing of polymer material are described. An example system may include a doping sub-system configured to dope a polymer material with one or more fluorescent molecules and an optical sub-system. The optical sub-system may include a laser source configured to irradiate the active growth region with an optical signal during the 3D printing of the polymer material to excite the fluorescent molecules, an optical image sensor configured to measure an intensity of light emitted from the excited fluorescent molecules to create a fluorescence intensity map, and one or more computing devices configured to scan the fluorescence intensity map to produce fluorescence intensity data.

According to further examples, systems to control fabrication of a 3D printed article are described. An example system may include a dopant module configured to dope a polymer material with one or more fluorescent molecules and a temperature monitoring module configured to monitor temperature of an active growth region during a 3D printing of the polymer material and generate instructions based on the monitored temperature, the temperature monitoring module comprising an optical system and a process control system. The example system may also include a characteristic modulation module configured to modulate one or more characteristics of the active growth region based on the instructions provided from the temperature monitoring module.

According to yet further examples, a computer-readable storage medium with instructions stored thereon is described, which when executed on one or more computing devices may execute a method to monitor a temperature of an active growth region during 3D printing of polymer material. The method may be similar to the example methods provided above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example of a polymer material doped with one or more fluorescent molecules;

FIG. 2 illustrates an example of an optical sub-system configured to generate a fluorescence intensity map during three-dimensional (3D) printing of polymer material;

FIG. 3 illustrates an example of a process control sub-system configured to convert a fluorescence intensity map received from an optical system to a temperature map;

FIG. 4 illustrates an example temperature map generated by a process control sub-system;

FIG. 5 illustrates an example system to control fabrication of a 3D printed article by monitoring a temperature of an active growth region during 3D printing of polymer material;

FIG. 6 illustrates a general purpose computing device, which may be used to monitor a temperature of an active growth region during 3D printing of polymer material;

FIG. 7 is a flow diagram illustrating an example method to monitor a temperature of an active growth region during 3D printing of polymer material that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar articles, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn to methods, apparatus, systems, devices, and/or computer program products related to controlling fabrication of a three-dimensional (3D) printed article by monitoring a temperature of an active growth region during a 3D printing of polymer material.

Briefly stated, technologies are generally described for controlling fabrication of a 3D printed article by monitoring a temperature of an active growth region during a 3D printing of polymer material. A polymer material may be doped with one or more fluorescent molecules, which may be excited during a 3D printing of the polymer material. An intensity of light emitted from the fluorescent molecules may be determined to create a fluorescence intensity map, which may be converted into a temperature map in order to monitor a temperature of the active growth region, and generate one or more instructions based on the monitored temperature. One or more characteristics of the active growth region may then be modulated based on the instructions provided. Modulating characteristics of the active growth region based on the monitored temperature may allow better process control, which may be used to enhance a speed and resolution of 3D printing systems.

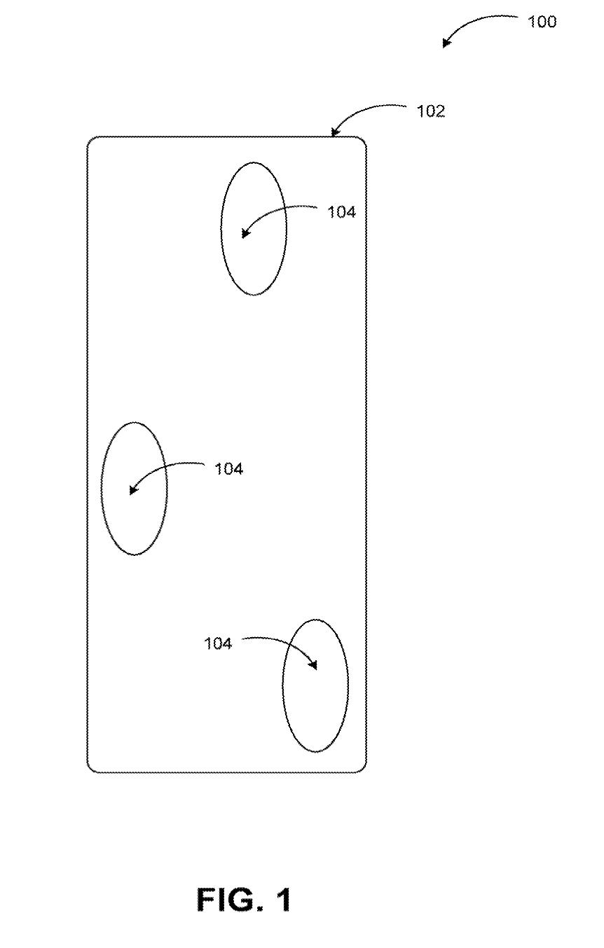

FIG. 1 illustrates an example of a polymer material doped with one or more fluorescent molecules, arranged in accordance with at least some embodiments described herein.

As shown in a diagram 100, a polymer material 102 may be doped with one or more fluorescent molecules 104 in a doping sub-system of a 3D printing system. A fluorescent molecule, as described herein, may be one that absorbs visible light energy irradiated from a light source and emits the energy as a photon of a different wavelength, so that the emission wavelength may be differentiated from the irradiation wavelength at which the energy was absorbed. The emission of the energy may be dependent on temperature, and thus temperature values may be indirectly determined by analysis of the emitted energy. For example, the emission intensity of the fluorescent molecule may decrease as temperature increases, allowing a direct correlation between measured intensity and temperature.

The polymer material 102 may be a filament or powder, and may be selected to be compatible with the fluorescent molecules 104, for example acrylonitrile butadiene styrene (ABS). Alternatively the fluorescent molecules 104 may be selected to be compatible with a particular polymer material. In one example, the polymer material 102 may be doped by dissolving the fluorescent molecules 104 and the polymer material 102 in a solvent and removing the solvent. In another example, the polymer material 102 may be doped by melt-processing the fluorescent molecules 104 with the polymer material 102 to dissolve the fluorescent molecules 104 in the polymer material 102. The polymer material 102 may be doped with the fluorescent molecules 104 at low concentration levels to prevent perturbation of polymer material 102 properties. The concentration level may generally be any concentration, such as a concentration of about 10 to about 1000 parts per million (ppm), for example about 10 ppm, about 100 ppm, about 200 ppm, about 300 ppm, about 400 ppm, about 500 ppm, about 600 ppm, about 700 ppm, about 800 ppm, about 900 ppm, about 1000 ppm, or any concentration between any of these stated values (including endpoints). Low concentration levels may also help to reduce a cost of doping.

The fluorescent molecules 104 may have one or more emission bands, such as phosphors or fluorophores having two emission bands. The emission bands may be on a same molecule or on two separate molecules. Multiple characteristics of phosphor or fluorophore emission may change as a function of temperature, and can be productively used to measure temperature. For example, a lifetime of phosphorescent or fluorescent decay, a wavelength of emission, and an intensity of emission.

One common technique for temperature measurement is to measure the decay rate of a phosphor or fluorophore because a large amount of information may be captured on the decay rate over time, and a more accurate curve may be generated in order to identify a temperature. However, the large amount of information captured may be costly to obtain and may present a challenge when taking high frame rate images as it may not be possible to process data fast enough to capture both at high resolution and high frame rate.

In another technique, the wavelength of the phosphor or fluorophore emission may be used for temperature measurement by mapping a color (wavelength) of the emitted light and subsequently mapping a temperature of the emission. While color mapping may benefit from a simple optical system and simple implementation, high resolution may be more challenging to achieve. In one example, the polymer material may be doped with two or more fluororphores, such as 1,3-bis(1-pyrenyl)propane and pyrene. Each fluorophore may emit light at a different wavelength and may respond differently to a change in temperature. In such a system, a more temperature-sensitive emission band may be monitored as a thermochromic probe, such as 1,3-bis(1-pyrenyl)propane, and the less temperature-sensitive emission band, such as pyrene, may serve as a control. In another example, the polymer material may be doped with a single fluorophore. Pi stacking of organic molecules, known to be highly dependent on temperature, may result in dramatic shifts in fluorescence emission, which may indicate a location of the active growth region as well as a temperature of the active growth region.

According to embodiments, the intensity of the phosphor or fluorophore emission may be used for temperature measurement by defining the two emission bands, one of which is more sensitive to a change in temperature than the other emission band, and monitoring the ratio of the intensity between the two bands. The two bands may exist on two separate molecules, or on a single molecule. The use of two molecules may increase the flexibility of the molecules that can be selected such that an appropriate molecule for varying temperature ranges may be selected, but the two molecules may remain homogenous in the polymer. The use of one molecule may simplify concerns about chemical mixing. While using the intensity of emission for temperature measurement may have a more complex optical system, higher resolution may be achieved and thus may be preferred. In one example, temperature may be measured using a single fluorophore to dope the polymer material, where the fluorophore is excited at one wavelength, yet contains two emission bands. The two emission bands corresponding to two different wavelengths, may have different sensitivity to temperature, and thus may serve as standards against each other. While multiple variations of temperature measurement techniques are described herein, a system according to some embodiments may determine the intensity of fluorophore emission to create a fluorescence intensity map, which may be converted to a temperature map and analyzed to modulate characteristics of the active growth region, as described in the remaining figures.

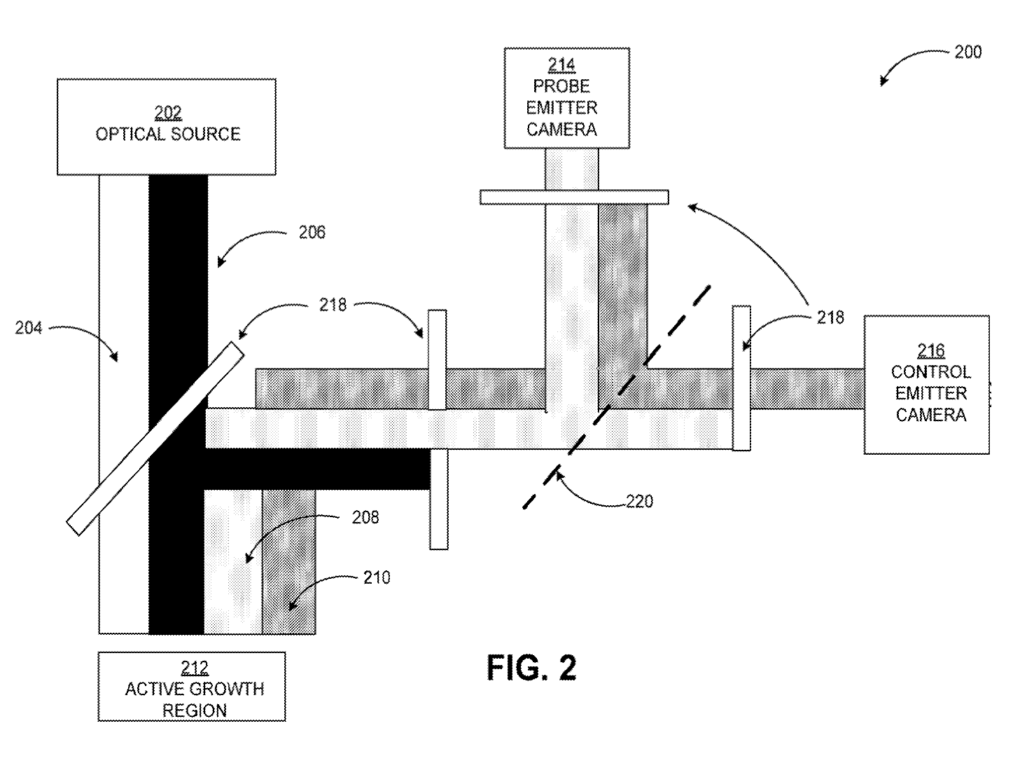

FIG. 2 illustrates an example of an optical sub-system configured to generate a fluorescence intensity map during 3D printing of polymer material, arranged in accordance with at least some embodiments described herein.

As shown in a diagram 200, an optical sub-system of a 3D printing system may include a laser source 202, one or more computing devices, such as a probe emitter camera 214 and a control emitter camera 216, a pellicle mirror 220, and one or more filters 218. The probe emitter camera 214 and the control emitter camera 216 may be high speed, black and white cameras and may include one or more optical image sensors, such as a charge-coupled device (CCD) or a complementary metal-oxide-semiconductor (CMOS) array. The optical sub-system may be configured to monitor a temperature of an active growth region 212 during 3D printing of a polymer material, such as the polymer material doped with one or more fluorescent molecules described previously in FIG. 1. The active growth region 212 may include a melt zone and one or more surrounding regions.

The laser source 202 may be configured to irradiate the active growth region 212 with one or more optical signals 204, 206. The optical signals may include laser light or infrared (IR) light. Irradiation may excite the fluorescent molecules causing light to be emitted from the fluorescent molecules at two distinct wavelengths 208 and 210, corresponding to two emission bands of the fluorescent molecules. One emission band may be more sensitive to temperature change, and the other emission band may be less sensitive to temperature change serving as a control. The emitted light may be filtered by at least one of the filters 218 to remove irradiated optical signals, split by the pellicle mirror 220, and then filtered by at least another one or the filters 218 before image collection at the optical image sensors of the probe emitter camera 214 and the control emitter camera 216.

The optical image sensor of each camera may be configured to determine an intensity of emitted light at one or more of the wavelengths. For example, the optical image sensor of the probe emitter camera 214 may be configured to determine an intensity of emitted light at wavelength 208, which may be more sensitive to temperature change. Accordingly, the optical image sensor of the control emitter camera 216 may be configured to determine an intensity of emitted light at wavelength 210, which may be less sensitive to temperature change serving as a control. The probe emitter camera 214 and the control emitter camera 216 may be configured to create a fluorescence intensity map using an intensity ratio between the emission bands determined from images collected by the optical image sensors. The probe emitter camera 214 and the control emitter camera 216 may further be configured to scan the fluorescence intensity map to produce fluorescence intensity data that may be transmitted to one or more other sub-systems of the 3D printing system. The other sub-systems may modulate one or more characteristics of the active growth region based on the instructions. In some embodiments, the optical system may also include a second laser source configured to photo-bleach the fluorescent molecules after the temperature of the active growth region is monitored and modulations to the active growth region are completed.

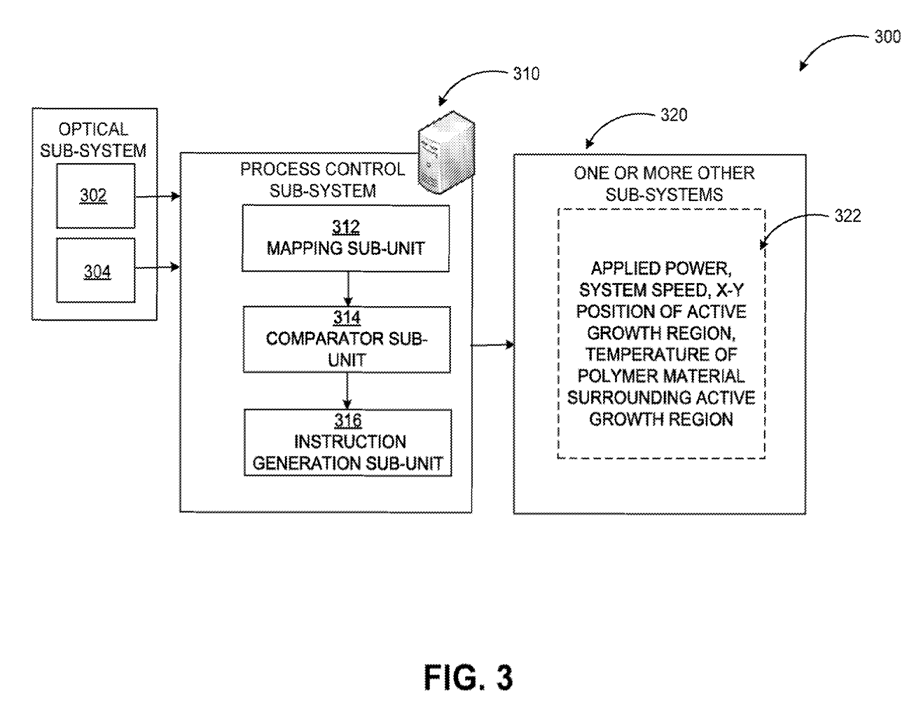

FIG. 3 illustrates an example of a process control sub-system configured to convert a fluorescence intensity map received from an optical system to a temperature map, arranged in accordance with at least some embodiments described herein.

As shown in a diagram 300, a process control sub-system of a 3D printing system may include a processor 310 configured to receive fluorescence intensity data from one or more computing devices 302, 304 of the optical sub-system, as discussed previously in FIG. 2. The processor 310 may include a mapping sub-unit 312, a comparator sub-unit 314, and an instruction generation sub-unit 316.

The mapping sub-unit 312 may be configured to generate a temperature map using the fluorescence intensity data received, and transmit the temperature map to the comparator sub-unit 314. The temperature map may be generated based on a ratio of fluorescence intensity data determined from images collected by one or more optical image sensors in the optical sub-system, according to instructions of a calibration curve or lookup table. The comparator sub-unit 314 may then compare the generated temperature map with a predefined optimal temperature map. If there are differences between the generated temperature map and the optimal temperature map, the differences may be analyzed and converted into instructions in the instruction generation sub-unit 316.

The instructions may then be transmitted from the processor 310 of the process control sub-system to one or more other sub-systems 320, such as a characteristic modulation sub-system. The other sub-systems 320 may be configured to modulate characteristics 322 of the active growth region based on the instructions. Modulated characteristics 322 may include an applied power, a system speed, an x-y position of the active growth region, or a temperature of the polymer material surrounding the active growth region, for example.

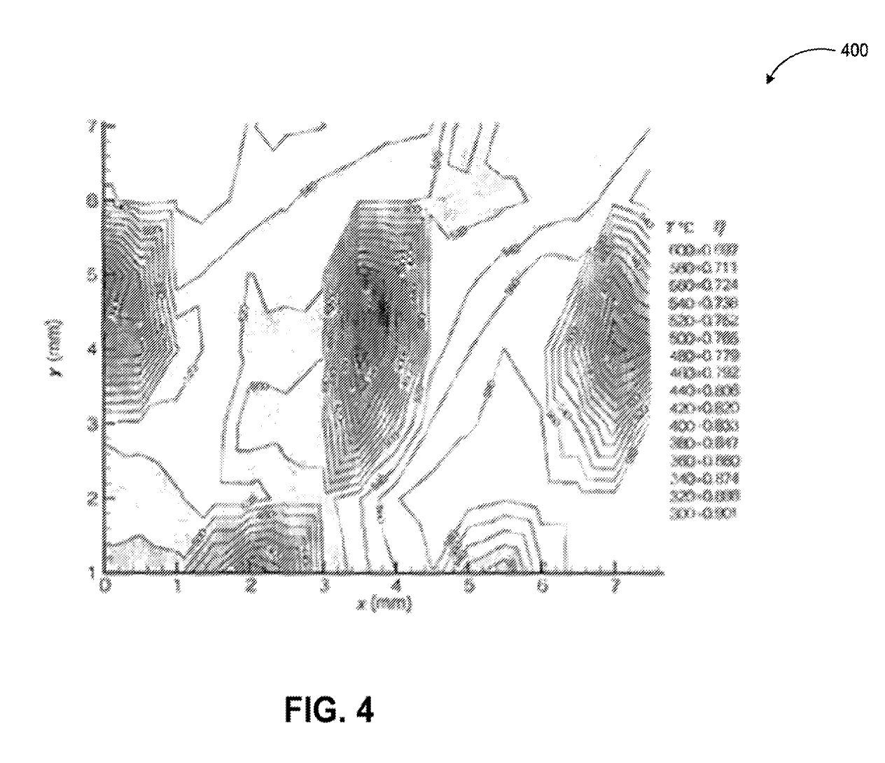

FIG. 4 illustrates an example temperature map generated by a process control sub-system, arranged in accordance with at least some embodiments described herein.

As shown in a diagram 400, a temperature map may be generated in a mapping sub-unit of a process control sub-system of a 3D printing system. Upon receiving fluorescence intensity data from an optical sub-system, the temperature map may be generated based on a ratio of the fluorescence intensity data between two emission bands determined from one or more optical image sensors, according to instructions of a calibration curve or lookup table.

The generated temperature map may be compared against a defined optimal temperature map, and differences between the generated temperature map and the optimal temperature map may be analyzed and converted into instructions. The instructions, when executed, may be configured to modulate characteristics of the active growth region. Modulated characteristics may include an applied power, a system speed, an x-y position of the active growth region, or a temperature of the polymer material surrounding the active growth region, for example. The ability to implement such characteristic modulations based on results of high speed and high resolution thermal imaging may allow greater control in fabrication of a 3D printed article. The greater control may allow printing of more complex articles that possess thinner walls, higher aspect ratio structures, and faster printing speeds.

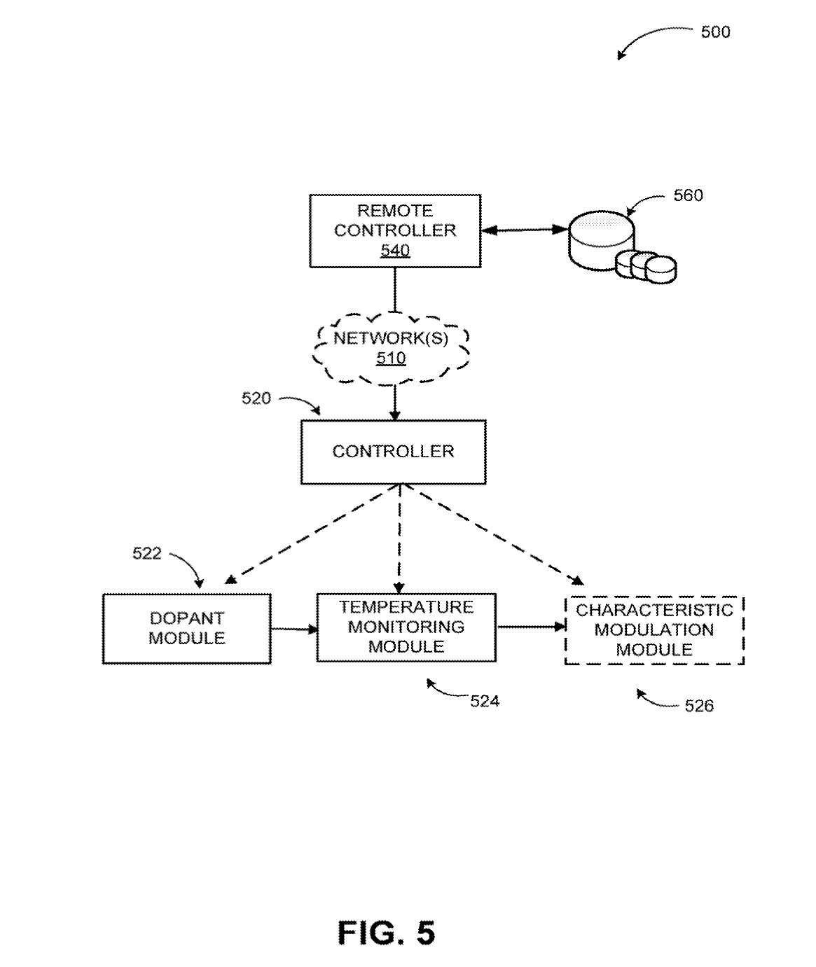

FIG. 5 illustrates an example system to control fabrication of a 3D printed article by monitoring a temperature of an active growth region during 3D printing of polymer material, arranged in accordance with at least some embodiments described herein.

System 500 may include at least one controller 520, at least one dopant module 522, at least one temperature monitoring module 524, and at least one characteristic modulation module 526. The controller 520 may be operated by human control or may be configured for automatic operation, or may be directed by a remote controller 550 through at least one network (for example, via network 510). Data associated with controlling the different processes of production may be stored at and/or received from data stores 560.

The controller 520 may include or control the dopant module 522 configured to dope a polymer material with one or more fluorescent molecules, and may also control the temperature monitoring module 524 configured to monitor temperature of an active growth region during a 3D printing of the polymer material, and generate instructions based on the monitored temperature. The controller 520 may also include or control a characteristic modulation module 526 configured to modulate one or more characteristics of the active growth region based on the instructions provided from the temperature monitoring module 524.

The dopant module 522 may comprise a doping sub-system of a 3D printing system configured to dope the polymer material with the fluorescents molecules by dissolving the fluorescent molecules and the polymer material in a solvent, and removing the solvent. Alternatively, the dopant module 522 may be configured to dope the polymer material with the fluorescent molecules by melt-processing the fluorescent molecules with the polymer material to dissolve the fluorescent molecules in the polymer material. The polymer material may be doped with the fluorescent molecules at low concentration levels to prevent or minimize perturbation of polymer material properties, from about 10 to 1000 parts per million (ppm), for example. The fluorescent molecules may be phosphors or fluorophores having multiple emission bands, for example, having two emission bands. The two bands may be exhibited by two separate molecules, or by a single molecule.

The temperature monitoring module 524 may comprise an optical sub-system and a process control sub-system of the 3D printing system. In the optical sub-system, a laser source may be configured to irradiate the active growth region with one or more optical signals. The irradiation may excite the fluorescent molecules in the polymer material, and light may be emitted from the excited fluorescent molecules at two or more distinct wavelengths corresponding to the two emission bands. One emission band may be more sensitive to a change in temperature and the other emission band may be less sensitive to a change in temperature, serving as a control. The emitted light may be filtered by one or more filters to remove the irradiated optical signals, split by a pellicle mirror, and then filtered by at least another one or more of the filters before image collection at one or more optical image sensors. The optical image sensors may be CCDs and/or CMOS arrays. Each optical image sensor may be configured to determine intensity of the light emitted at one of the distinct wavelengths. One or more computing devices associated with the optical image sensors may create a fluorescence intensity map using an intensity ratio between the emission bands determined from images collected by the optical image sensors. The computing devices may be high speed, black and white cameras, for example. The one or more computing devices may be further configured to scan the fluorescence intensity map to produce fluorescence intensity data that may be transmitted to one or more other sub-systems of the 3D printing system.

In the process control sub-system of the temperature monitoring module 524, a processor comprising a mapping sub-unit, a comparator sub-unit, and an instruction generation sub-unit may be configured to receive the fluorescence intensity data from the computing devices of the optical sub-system. The mapping sub-unit may be configured to generate a temperature map using the fluorescence intensity data received. The temperature map may be generated based on a ratio of fluorescence intensity data determined from images collected by the optical image sensors in the optical sub-system, according to instructions of a calibration curve or lookup table. The comparator sub-unit may compare the generated temperature map with a predefined optimal temperature map. If there are differences between the generated temperature map and the optimal temperature map, the instruction generation sub-unit may analyze the differences and convert the differences into instructions. The instructions may then be transmitted from the processor to one or more other sub-systems, such as a characteristic modulation sub-system.

The characteristic modulation module 526 may include a characteristic modulation sub-system of the 3D printing system. The characteristic modulation module 526 may be configured to modulate characteristics of the active growth region based on the instructions received from the processor of the process control sub-system. Modulated characteristics may include an applied power, a system speed, an x-y position of the active growth region, or a temperature of the polymer material surrounding the active growth region, for example.

The examples in FIGS. 1 through 5 have been described using specific processes, systems, and modules to monitor a temperature of an active growth region during 3D printing of polymer material in order to control fabrication of a 3D printed article. Embodiments to monitor a temperature of an active growth region during 3D printing of polymer material are not limited to the specific processes, systems, and modules according to these examples.

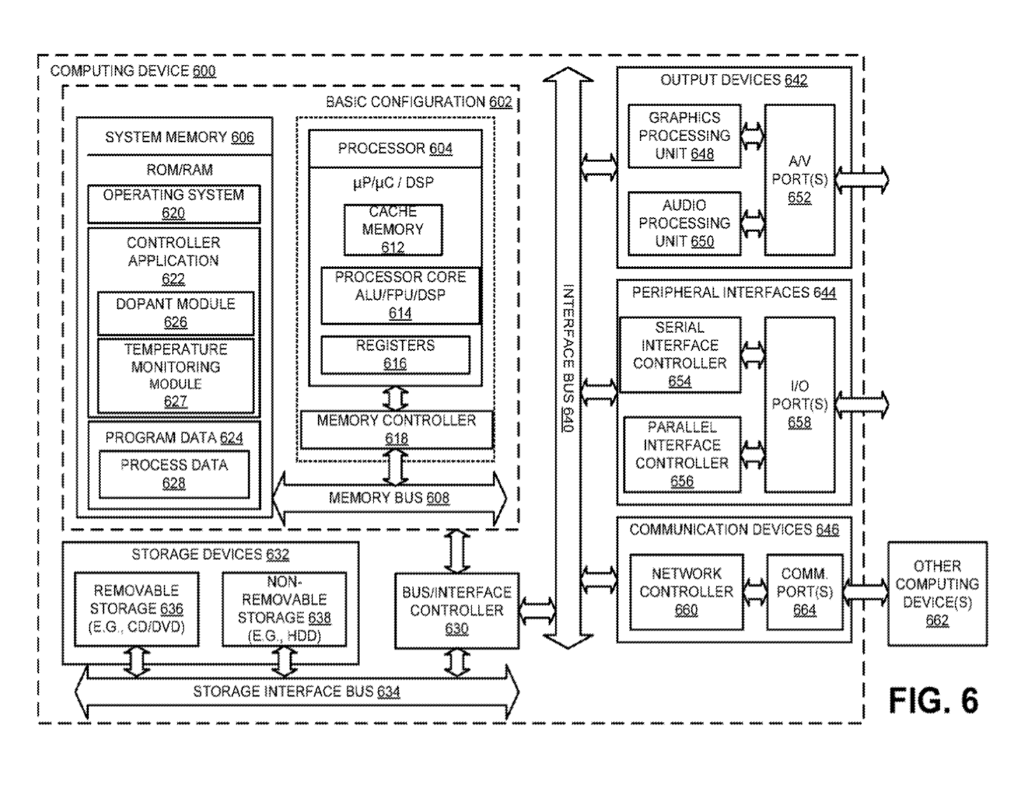

FIG. 6 illustrates a general purpose computing device, which may be used to monitor a temperature of an active growth region during three-dimensional (3D) printing of polymer material, arranged in accordance with at least some embodiments described herein.

For example, the computing device 600 may be used as a server, desktop computer, portable computer, smart phone, special purpose computer, or similar device such as a controller, a new component, a cluster of existing components in an operational system including a vehicle and a smart dwelling. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a controller application 622, and program data 624. The controller application 622 may include a dopant module 626 and a temperature monitoring module 627, which may be an integral part of the application or a separate application on its own. The dopant module 626 may be configured to dope a polymer material with one or more fluorescent molecules. The temperature monitoring module 627 may include an optical system configured to excite the fluorescent molecules and determine intensity of light emitted from the fluorescent molecules to a fluorescence intensity map. The temperature monitoring module 627 may also include a process control system configured to convert the fluorescence intensity map to a temperature map and compare the temperature map to a predefined optimal temperature map. Differences between the temperature map and the predefined optimal map may be analyzed and converted into instructions, which may be transmitted to other systems of the 3D printing system to be implemented, such as a characteristic modulation system. The program data 624 may include, among other data, process data 628 related to doping and temperature monitoring, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include a system comprising one or more sub-systems employed to monitor temperature of an active growth region during three-dimensional (3D) printing of polymer material in order to control fabrication of a 3D printed article. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated

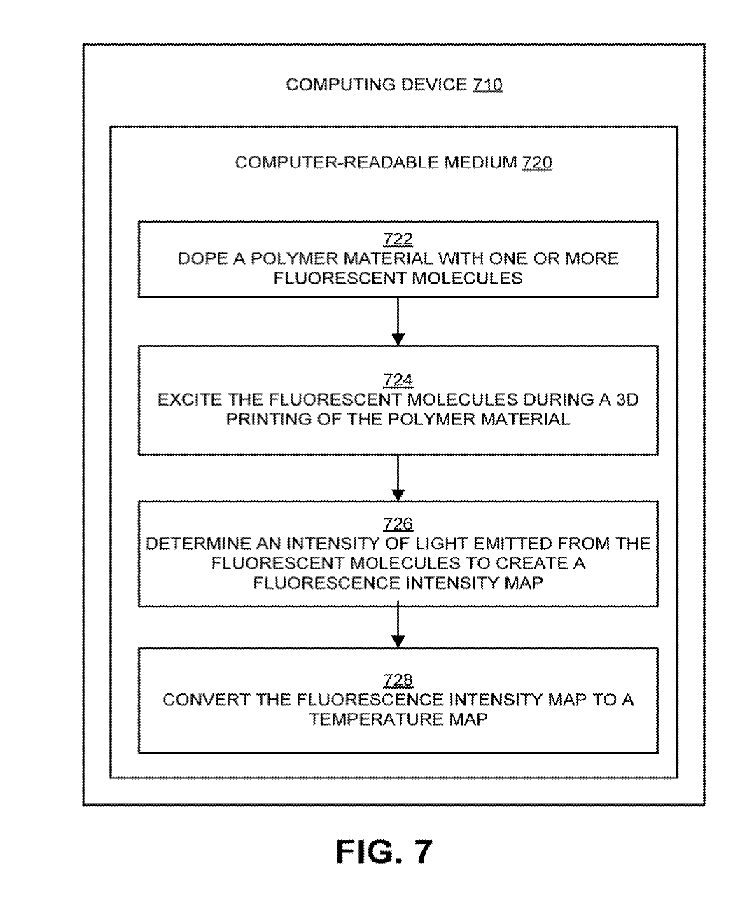

FIG. 7 is a flow diagram illustrating an example method to monitor a temperature of an active growth region during 3D printing of polymer material that may be performed by a computing device such as the computing device in FIG. 6, arranged in accordance with at least some embodiments described herein.

Example methods may include one or more operations, functions or actions as illustrated by one or more of blocks 722, 724, 726 and/or 728. The operations described in the blocks 722 through 728 may also be stored as computer-executable instructions in a computer-readable medium such as a computer-readable medium 720 of a computing device 710.

An example process to increase interlayer adhesion of a 3D printed article may begin with block 722, “DOPE A POLYMER MATERIAL WITH ONE OR MORE FLUORESCENT MOLECULES,” where a doping sub-system of a 3D printing system may be configured to dope a polymer material with one or more fluorescent molecules by dissolving the fluorescent molecules and the polymer material in a solvent and removing the solvent. Alternatively, the polymer material may be doped with the fluorescent molecules by melt-processing the fluorescent molecules with the polymer material to dissolve the fluorescent molecules in the polymer material. The polymer material may be doped with the fluorescent molecules at low concentration levels to prevent perturbation of polymer material properties, such as about 10 to about 1000 parts per million (ppm), as described above. The fluorescent molecules may be phosphors or fluorophores comprising two emission bands. The bands may be on a same molecule or on two separate molecules.

Block 722 may be followed by block 724, “EXCITE THE FLUORESCENT MOLECULES DURING A 3D PRINTING OF THE POLYMER MATERIAL,” where a laser source of an optical sub-system may be configured to irradiate the active growth region with one or more optical signals. The irradiation may excite the fluorescent molecules in the polymer material, and light may be emitted from the fluorescent molecules at two distinct wavelengths corresponding to the two emission bands. One emission band may be more sensitive to temperature change and the other emission band may be less sensitive to temperature change, serving as the control. The emitted light may be filtered by one or more filters to remove the irradiated optical signals, split by a pellicle mirror, and then filtered by at least another one or more of the filters before image collection at one or more optical image sensors.

Block 724 may be followed by block 726, “DETERMINE AN INTENSITY OF LIGHT EMITTED FROM THE FLUORESCENT MOLECULES TO CREATE A FLUORESCENCE INTENSITY MAP,” where each of the optical image sensors may be configured to determine intensity of the light emitted at one of the distinct wavelengths. One or more computing devices associated with the optical image sensors may create a fluorescence intensity map using an intensity ratio between the emission bands determined from the images collected from the optical image sensors. The one or more computing devices may be further configured to scan the fluorescence intensity map to produce fluorescence intensity data that may be transmitted to one or more other sub-systems of the 3D printing system.

Block 726 may be followed by block 728, “CONVERT THE FLUORESCENCE INTENSITY MAP TO A TEMPERATURE MAP,” where a process control sub-system may be configured to receive the fluorescence intensity data from the computing devices of the optical sub-system. A temperature map may be generated using the fluorescence intensity data received. The temperature map may be based on a ratio of fluorescence intensity data between the two emission bands determined from images collected by the optical image sensors in the optical sub-system, according to instructions of a calibration curve or lookup table. In additional embodiments, the generated temperature map may be compared with a predefined optimal temperature map. If there are differences between the generated temperature map and the optimal temperature map, the differences may be analyzed and converted into instructions. The instructions may then be transmitted to one or more other sub-systems configured to modulate characteristics of the active growth region based on the instructions.

The blocks included in the above described process are for illustration purposes. Temperature monitoring of an active growth region during 3D printing of polymer material may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

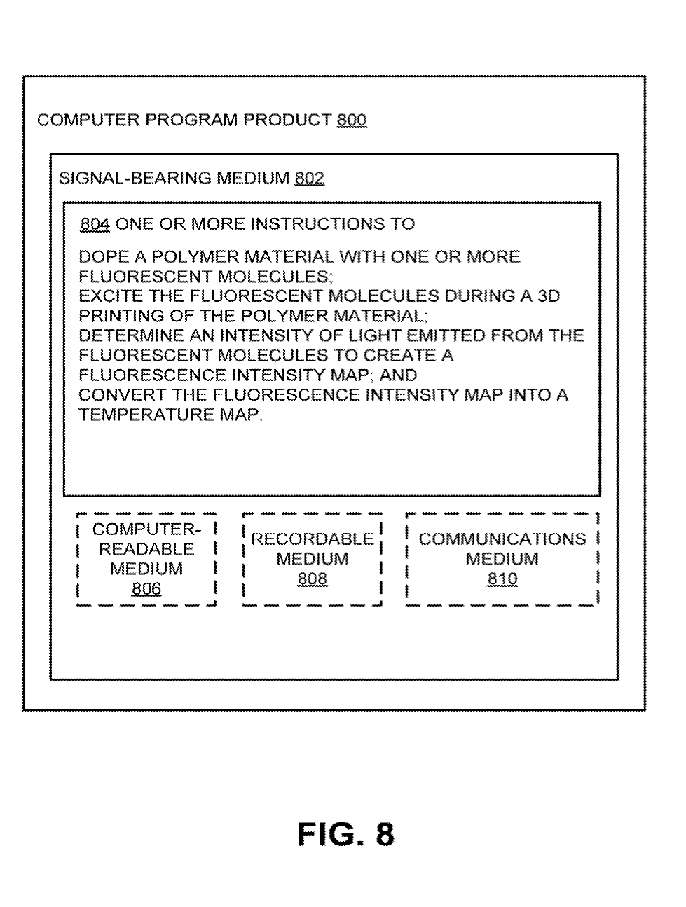

FIG. 8 illustrates a block diagram of an example computer program product, arranged in accordance with at least some embodiments described herein.

In some embodiments, as shown in FIG. 8, the computer program product 800 may include a signal bearing medium 802 that may also include one or more machine readable instructions 804 that, when executed by, for example, a processor, may provide the functionality described herein. Thus, for example, referring to the processor 604 in FIG. 6, a dopant module 626 and a temperature monitoring module 627 executed on the processor 604 may undertake one or more of the tasks shown in FIG. 8 in response to the instructions 804 conveyed to the processor 604 by the medium 802 to perform actions associated with temperature monitoring of an active growth region during 3D printing of polymer material as described herein. Some of those instructions may include, for example, one or more instructions to dope a polymer material with one or more fluorescent molecules, excite the fluorescent molecules during a 3D printing of the polymer material, determine an intensity of light emitted from the fluorescent molecules to create a fluorescent intensity map, and convert the fluorescence intensity map into a temperature map, according to some embodiments described herein.

In some implementations, the signal bearing medium 802 depicted in FIG. 8 may encompass a computer-readable medium 806, such as, but not limited to, a hard disk drive, a solid state drive, a Compact Disc (CD), a Digital Versatile Disk (DVD), a digital tape, memory, and so on. In some implementations, the signal bearing medium 802 may encompass a recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (for example, a fiber optic cable, a waveguide, a wired communications link, a wireless communication link, and so on). Thus, for example, the program product 800 may be conveyed to one or more modules of the processor 604 of FIG. 6 by an RF signal bearing medium, where the signal bearing medium 802 is conveyed by the wireless communications medium 810 (for example, a wireless communications medium conforming with the IEEE 802.11 standard).

According to some examples, methods for monitoring a temperature of an active growth region during 3D printing of polymer material are provided. An example method may include doping a polymer material with one or more fluorescent molecules and exciting the fluorescent molecules during a 3D printing of the polymer material. The example method may also include determining an intensity of light emitted from the fluorescent molecules to create a fluorescence intensity map and converting the fluorescence intensity map into a temperature map.

In other examples, the fluorescent molecules and the polymer material may be dissolved in a solvent and the solvent then removed to dope the polymer material with the fluorescent molecules. The fluorescent molecules may also be melt-processed with the polymer material to dissolve the fluorescent molecules in the polymer material to dope the polymer material with the fluorescent molecules. The active growth region may be irradiated with an optical signal during the 3D printing of the polymer material to excite the fluorescent molecules, where the active growth region may include a melt zone and one or more surrounding regions.

In further embodiments, in order to convert the fluorescence intensity map into a temperature map, the fluorescence intensity map may be scanned to produce fluorescence intensity data and the temperature map may be generated using the fluorescence intensity data. The temperature map may be compared with a predefined optimal temperature map. Characteristics of the active growth region may be modulated in response to a determination that there are differences between the temperature map and the predefined optimal temperature map, wherein an applied power, a system speed, an x-y position of the active growth region, and/or a temperature of the polymer material surrounding the active growth region may be modulated.

According to some embodiments, systems to monitor a temperature of an active growth region during 3D printing of polymer material are described. An example system may include a doping sub-system configured to dope a polymer material with one or more fluorescent molecules and an optical sub-system. The optical sub-system may include a laser source configured to irradiate the active growth region with an optical signal during the 3D printing of the polymer material to excite the fluorescent molecules, an optical image sensor configured to measure an intensity of light emitted from the excited fluorescent molecules to create a fluorescence intensity map, and one or more computing devices configured to scan the fluorescence intensity map to produce fluorescence intensity data.

In other embodiments, the example system may also include a process control sub-system that may include a memory configured to store instructions and a processor coupled to the memory. The processor may be configured to receive the fluorescence intensity data from the computing devices of the optical system at the processor, generate a temperature map in a mapping unit of the processor using the fluorescence intensity data, compare the generated temperature map with a predefined optimal temperature map in a comparator subunit of the processor, and in response to a determination that there are differences between the generated temperature map and the optimal temperature map, analyze and convert the differences into instructions in an instruction generator subunit of the processor. The instructions may be transmitted to one or more sub-systems to modulate an applied power, a system speed, an x-y position of the active growth region, and/or a temperature of the polymer material surrounding the active growth region.

In further embodiments, the optical signal may be a laser light or infrared light. The polymer material may be a filament or a powder, where the polymer material may be doped with the fluorescent molecules at a concentration between 10 and 1000 parts per million (ppm). The fluorescent molecules may be fluorophores comprising two emission bands. The optical image sensor may be a charge-coupled device (CCD) or a complementary metal-oxide-semiconductor (CMOS) array. The computing devices may include high-speed, black and white cameras that further include a filter configured to remove light irradiated from the laser source. The intensity of light emitted may be measured from two emission bands of the excited fluorescent molecules, where the two emission bands may be on a same fluorescent molecule or two different fluorescent molecules and the fluorescent intensity data may include measurements of intensity of light ratios between the two emission bands.

According to some examples, systems to control fabrication of a 3D printed article are described. An example system may include a dopant module configured to dope a polymer material with one or more fluorescent molecules and a temperature monitoring module configured to monitor temperature of an active growth region during a 3D printing of the polymer material and generate instructions based on the monitored temperature, the temperature monitoring module comprising an optical system and a process control system. The example system may also include a characteristic modulation module configured to modulate one or more characteristics of the active growth region based on the instructions provided from the temperature monitoring module.

In other examples, the dopant module may be configured to dope the polymer material by dissolving the fluorescent molecules and the polymer material in a solvent and removing the solvent or melt-processing the fluorescent molecules with the polymer material to dissolve the fluorescent molecules in the polymer material. The optical system of the temperature monitoring module may be configured to irradiate the active growth region using a laser source to excite the fluorescent molecules in the doped polymer material, remove light irradiated from the laser source using a filter, measure an intensity of light emitted from the excited fluorescent molecules using an optical image sensor, create a fluorescence intensity map based on the measured intensity of light, and scan the fluorescence intensity map to produce fluorescence intensity data.

In further examples, the process control system of the temperature monitoring module may be configured to receive fluorescence intensity data from the optical system, generate a temperature map using the fluorescence intensity data, compare the generated temperature map with a predefined optimal temperature map, in response to a determination that there are differences between the generated temperature map and the predefined optimal temperature map, analyze and convert the differences into the instructions, and provide the instructions to the characteristic modulation module. The instructions provided to the characteristic modulation module may include instructions to modulate an applied power, a system speed, an x-y position of the active growth region, and/or a temperature of the polymer material surrounding the active growth region. The optical system may further include a second laser source configured to photo-bleach the fluorescent molecules after the temperature of the active growth region is monitored and modulations to the active growth region are completed.

According to some embodiments, a computer-readable storage medium with instructions stored thereon is described, which when executed on one or more computing devices may execute a method to monitor a temperature of an active growth region during 3D printing of polymer material. The method may be similar to the example methods provided above.

### EXAMPLES

Following are illustrative examples of how some embodiments may be implemented, and are not intended to limit the scope of embodiments in any way.

### Example 1

### Intensity Detection Using Single Fluorophore with Two Emission Bands to Monitor Temperature of Active Growth Region During 3D Printing Process

In one example, acrylonitrile butadiene styrene (ABS) may be doped with a single fluorophore, N,N-bis(2,5-ditertbutylphenyl)-3,4,9,10-perylenedi carboximide, by melt-processing to dissolve the N,N-bis(2,5-ditertbutylphenyl)-3,4,9,10-perylenedi carboximide in the ABS. The single fluorophore may have two emission bands, corresponding to two distinct wavelengths, which may have a different response to temperature, and thus may serve as standards against each other. For example, a first emission band at 400 nm may be less sensitive to a change in temperature than a second emission band at 485 nm. Therefore, the second emission band may change more dramatically in response to a change in temperature.

During a 3D printing of an article using the doped ABS, an infrared (IR) laser may be configured to radiate an active growth region with IR light to excite the N,N-bis(2,5-ditertbutylphenyl)-3,4,9,10-perylenedi carboximide in the ABS. Light may be emitted at the first and second emission band in response to the irradiation. The emitted light may be filtered by one or more filters to remove the irradiated IR light, split by a pellicle mirror, and then filtered by at least another one or more of the filters before image collection at a first and a second high speed, black and white camera. Each of the cameras may have an optical image sensor that is a charge-coupled device (CCD) array configured to determine an intensity of light emitted from the N,N-bis(2,5-ditertbutylphenyl)-3,4,9,10-perylenedi carboximide. The first camera may be configured to determine an intensity of light emitted from the N,N-bis(2,5-ditertbutylphenyl)-3,4,9,10-perylenedi carboximide at the first emission band. The second camera may be configured to determine an intensity of light emitted from the N,N-bis(2,5-ditertbutylphenyl)-3,4,9,10-perylenedi carboximide at the second emission band. A fluorescence intensity map may then be created using an intensity ratio of light emitted between the two emission bands. The fluorescence intensity map may be scanned to produce fluorescence intensity data which may be used to generate a temperature map based on the intensity ratio.

The generated temperature map may be compared with a predefined optimal temperature map. If there are differences between the generated temperature map and the optimal temperature map, the differences may be analyzed and converted into instructions. The instructions may include characteristics of the active growth region to modulate. For example, an x-y position of the active growth region may be modified to optimize the temperature of the active growth region in order to improve the 3D printing process.

### Example 2

### Radiometric Detection Using Two Fluorophores to Monitor Temperature of Active Growth Region During 3D Printing Process

In another example, ABS may be doped with two fluorophores, such as 1,3-bis(1-pyrenyl)propane and pyrene by dissolving the ABS, 1,3-bis(1-pyrenyl)propane, and pyrene in a solvent and removing the solvent. The 1,3-bis(1-pyrenyl)propane may serve as a thermochromic probe and pyrene may serve as a control. These fluorophores may be chemically alike and thus are unlikely to segregate, and function to a temperature of about 230° C. Each fluorophore may emit energy at different wavelengths and may have different responses to temperature. For example, an emission band of the pyrene at 400 nm may be less sensitive to a change in temperature than an emission band of the 1,3-bis(1-pyrenyl)propane at 485 nm. Therefore, the larger, more temperature-sensitive emission band from 1,3-bis(1-pyrenyl)propane at 485 nm may be monitored by the system, with the pyrene serving as a control. During a 3D printing of an article using the doped ABS, the wavelength of the fluorophores' emissions may be used for temperature measurement by mapping a color of the emitted light and subsequently mapping a temperature of the emission.

The temperature map may be compared with a predefined optimal temperature map. If there are differences between the generated temperature map and the optimal temperature map, the differences may be analyzed and converted into instructions. The instructions may include characteristics of the active growth region to modulate. For example, a temperature of the polymer material surrounding the active growth region may be increased and/or decreased to optimize the 3D printing process.

### Example 3

### Wavelength Detection Using a Single Fluorophore to Monitor Temperature of Active Growth Region During 3D Printing Process

In a further example, ABS may be doped with a single fluorophore, 1,4-bis(a-cyano-4-methoxystyryl)benzene by melt-processing the 1,4-bis(a-cyano-4-methoxystyryl)benzene in the ABS to dissolve. The pi stacking of 1,4-bis(a-cyano-4-methoxystyryl)benzene, known to be highly dependent on temperature, may display significant transitions in wavelength across the melt transition of the ABS, greater than 100 nm in peak position, for example, and may thereby dramatically indicate the location of the active growth region as well as its temperature. During a 3D printing of an article using the doped ABS, the wavelength of the fluorophore's emission may be used for temperature measurement by mapping a color of the emitted light and subsequently mapping a temperature of the emission.

The temperature map may be compared with a predefined optimal temperature map. If there are differences between the generated temperature map and the optimal temperature map, the differences may be analyzed and converted into instructions. The instructions may include characteristics of the active growth region to modulate. For example, an amount of applied power or a speed of the 3D printing system may be adjusted to optimize the 3D printing process.

There are various vehicles by which processes and/or systems and/or other technologies described herein may be effected (for example, hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various compositions, methods, systems, and devices are described in terms of “comprising” various components or steps (interpreted as meaning “including, but not limited to”), the compositions, methods, systems, and devices can also “consist essentially of” or “consist of” the various components and steps, and such terminology should be interpreted as defining essentially closed-member groups.”

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be possible from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly intractable and/or wirelessly interacting components and/or logically interacting and/or logically intractable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to monitor a temperature of an active growth region during a three-dimensional (3D) printing of a polymer material, the method comprising:
doping the polymer material with one or more fluorescent molecules;
exciting the one or more fluorescent molecules during the 3D printing of the polymer material;
determining an intensity of light emitted from the one or more fluorescent molecules to create a fluorescence intensity map; and
converting the fluorescence intensity map into a temperature map.

2. The method of claim 1, wherein doping the polymer material with the one or more fluorescent molecules comprises:
dissolving the one or more fluorescent molecules and the polymer material in a solvent and removing the solvent.

3. The method of claim 1, wherein doping the polymer material with the one or more fluorescent molecules comprises:
melt-processing the one or more fluorescent molecules with the polymer material to dissolve the one or more fluorescent molecules in the polymer material.

4. The method of claim 1, wherein exciting the one or more fluorescent molecules comprises:
irradiating the active growth region with an optical signal during the 3D printing of the polymer material to excite the one or more fluorescent molecules.

5. The method of claim 4, wherein irradiating the active growth region comprises irradiating an active growth region that includes a melt zone and one or more surrounding regions.

6. The method of claim 1, wherein converting the fluorescence intensity map into the temperature map comprises:
scanning the fluorescence intensity map to produce fluorescence intensity data; and
generating the temperature map using the fluorescence intensity data.

7. The method of claim 1, further comprising:
comparing the temperature map with a reference temperature map.

8. The method of claim 7, further comprising:
in response to a determination of differences between the temperature map and the reference temperature map, modulating characteristics of the active growth region.

9. The method of claim 8, wherein modulating the characteristics of the active growth region comprises:
modulating one or more of an applied power, a system speed, or an x-y position of the active growth region, or a temperature of the polymer material that surrounds the active growth region.

10. A system to monitor a temperature of an active growth region during a three-dimensional (3D) printing of a polymer material, the system comprising:
a doping sub-system configured to dope the polymer material with one or more fluorescent molecules; and
an optical sub-system comprising:
a light source configured to irradiate the active growth region with an optical signal during the 3D printing of the polymer material to excite the one or more fluorescent molecules;
an optical image sensor configured to measure an intensity of light emitted from the one or more fluorescent molecules to create a fluorescence intensity map; and
one or more computing devices configured to scan the fluorescence intensity map to produce fluorescence intensity data.

11. The system of claim 10, further comprising:
a process control sub-system comprising:
a processor configured to:
receive the fluorescence intensity data from the one or more computing devices of the optical system at the processor;
generate a temperature map in a mapper unit of the processor using the fluorescence intensity data;
compare the temperature map with a reference temperature map in a comparator subunit of the processor; and
in response to a determination of differences between the temperature map and the reference temperature map, analyze and convert the differences into instructions in an instruction generator subunit of the processor.

12. The system of claim 11, wherein the instructions are transmitted to one or more sub-systems to modulate one or more of: an applied power, a system speed, an x-y position of the active growth region, and a temperature of the polymer material that surrounds the active growth region.

13. The system of claim 10, wherein the optical signal includes one of laser light and infrared light.

14. The system of claim 10, wherein the polymer material includes a filament or a powder.

15. The system of claim 10, wherein the polymer material is doped with the one or more fluorescent molecules at a concentration between about 10 parts per million (ppm) and 1000 ppm.

16. The system of claim 10, wherein the one or more fluorescent molecules include fluorophores comprising two emission bands.

17. The system of claim 10, wherein the optical image sensor includes one of a charge-coupled device (CCD) and a complementary metal-oxide-semiconductor (CMOS) array.

18. The system of claim 10, wherein the one or more computing devices include either or both:
high-speed black and white cameras; or
a filter configured to remove light irradiated from the light source.

19. (canceled)

20. The system of claim 10, wherein the intensity of light emitted is measured from two emission bands of the one or more fluorescent molecules.

21. The system of claim 20, wherein the two emission bands are on a same fluorescent molecule of the one or more fluorescent molecules or are on two different fluorescent molecules of the one or more fluorescent molecules.

22. The system of claim 20, wherein the fluorescent intensity data includes ratio measurements of the intensity of the light between the two emission bands.

23. A system to control fabrication of a three-dimensional (3D) printed article, the system comprising:
a dopant module configured to dope a polymer material with one or more fluorescent molecules;
a temperature monitor module that includes an optical system and a process control system, wherein the temperature monitor module is configured to:
monitor a temperature of an active growth region during a three-dimensional (3D) printing of the polymer material; and
generate instructions based on the temperature; and
a characteristic modulation module configured to:
modulate one or more characteristics of the active growth region based on the instructions generated by the temperature monitor module.

24. The system of claim 23, wherein the dopant module is configured to:
dope the polymer material by one of:
dissolve the one or more fluorescent molecules and the polymer material in a solvent and remove the solvent; and
melt-process the one or more fluorescent molecules with the polymer material to dissolve the one or more fluorescent molecules in the polymer material.

25. The system of claim 23, wherein the optical system is configured to:
irradiate the active growth region using a laser source to excite the one or more fluorescent molecules in the doped polymer material;
remove light irradiated from the laser source by use of a filter;
measure an intensity of the light emitted from the one or more fluorescent molecules by use of an optical image sensor;
create a fluorescence intensity map based on the intensity of the light; and
scan the fluorescence intensity map to produce fluorescence intensity data.

26. The system of claim 23, wherein the process control system is configured to:
receive fluorescence intensity data from the optical system;
generate a temperature map using the fluorescence intensity data;
compare the temperature map with a reference temperature map;
in response to a determination that there are differences between the temperature map and the reference temperature map, analyze and convert the differences into the instructions; and
provide the instructions to the characteristic modulation module.

27. (canceled)

28. The system of claim 23, wherein the optical system comprises:
a laser source configured to photo-bleach the one or more fluorescent molecules after the temperature of the active growth region is monitored and modulations of the one or more characteristics of the active growth region are completed.

29. A computer-readable storage medium with instructions stored thereon to monitor the temperature of the active growth region during the 3D printing of the polymer material, the instructions causing the method of claim 1 to be performed in response to execution of the instructions by one or more processors.
